(19) United States
(12) Patent Application Publication
(10) Pub. No.: US 2015/0127426 A1
(43) Pub. Date: May 7, 2015

(54) EXPERIENCE MANAGEMENT SYSTEM AND METHOD

(71) Applicant: Drop Thought,Inc., Santa Clara, CA (US)

(72) Inventor: Karan Chaudhry, Palo Alto, CA (US)

(21) Appl. No.: 14/530,572

(22) Filed: Oct. 31, 2014

Related U.S. Application Data
(60) Provisional application No. 61/898,711, filed on Nov. 1, 2013.

(51) Int. Cl. G06Q 30/02

(52) U.S. Cl. CPC G06Q 30/0203
USPC 705/7.32

(57) ABSTRACT

A computer-implemented method is provides. The method comprises receiving feedback messaged from a plurality of users via a network, each feedback message capturing user experience information for a user; classifying the feedback messages based on content into at least two categories comprising a negative category for feedback messages of a negative nature and a positive category comprising feedback messages of a positive nature; providing a dashboard for a manger to view at least the feedback message in the negative category, and marking those feedback messages that are most negative in nature; and polling each user who sent a feedback message of a negative nature to determine if a reply to said feedback message for found to be satisfactory.

### PRIORITY

This application claims the benefit of priority to U.S. 61/898,711 filed on Nov. 1, 2013 and entitled “EXPERIENCE MANAGEMENT SYSTEM AND METHOD”.

### BACKGROUND

A customer's experience is a very important determinant of whether not the customer will remain loyal to a business, product, or service.

### BRIEF DESCRIPTION

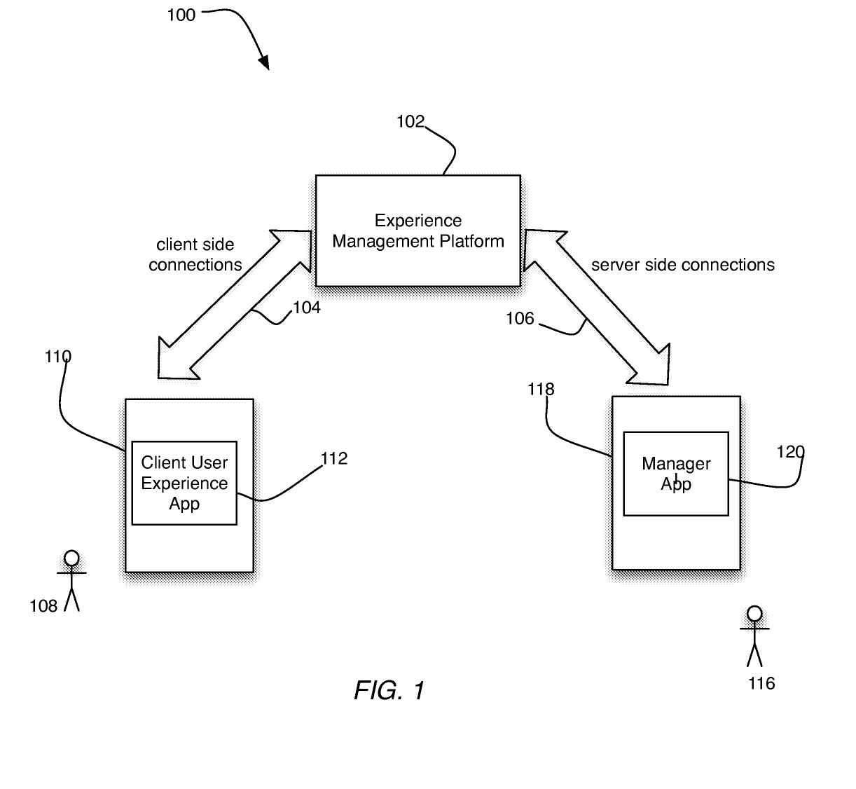

FIG. 1 shows a high level deployment scenario 100, in accordance with one embodiment of the invention.

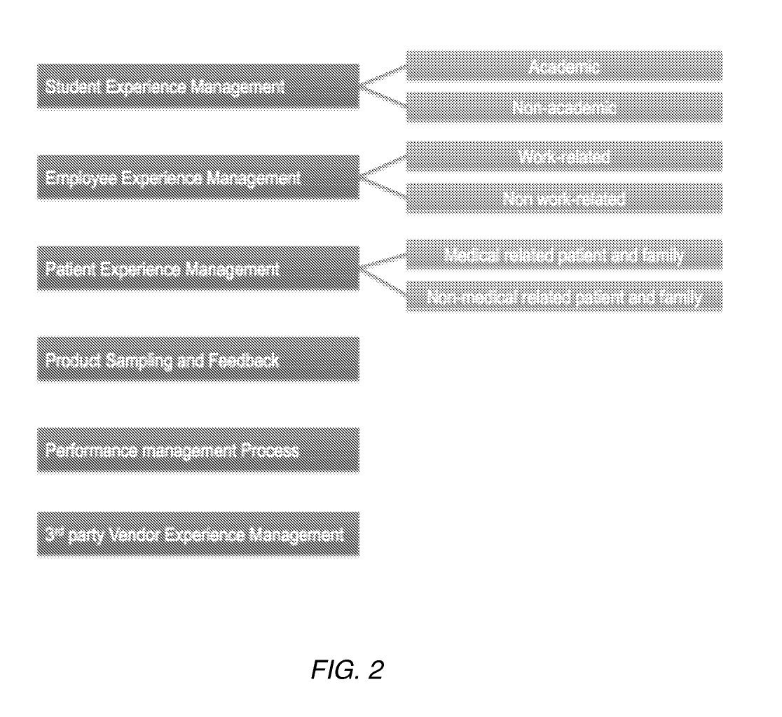

FIG. 2 shows the different experience management channels, in accordance with one embodiment.

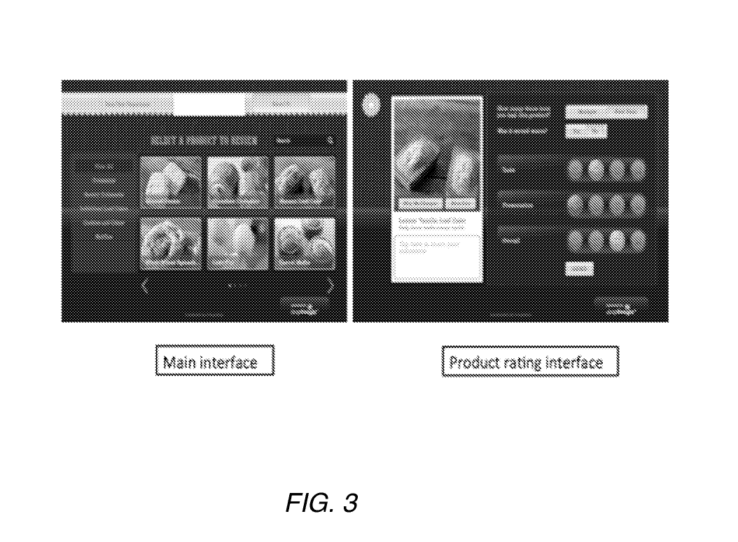

FIG. 3 shows a sample user interface (UI) for product sampling and feedback management, in accordance with one embodiment.

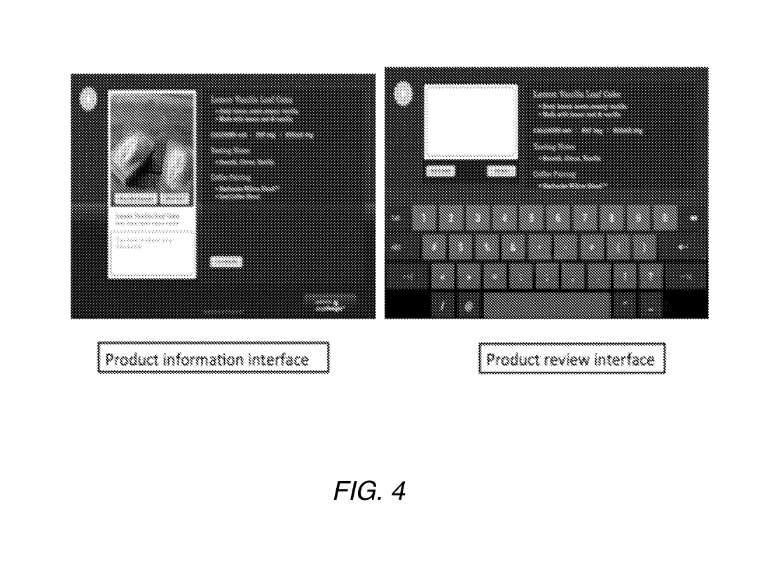

FIG. 4 shows another example of a user interface (UI) product information interface, and a product review interface, in accordance with one embodiment.

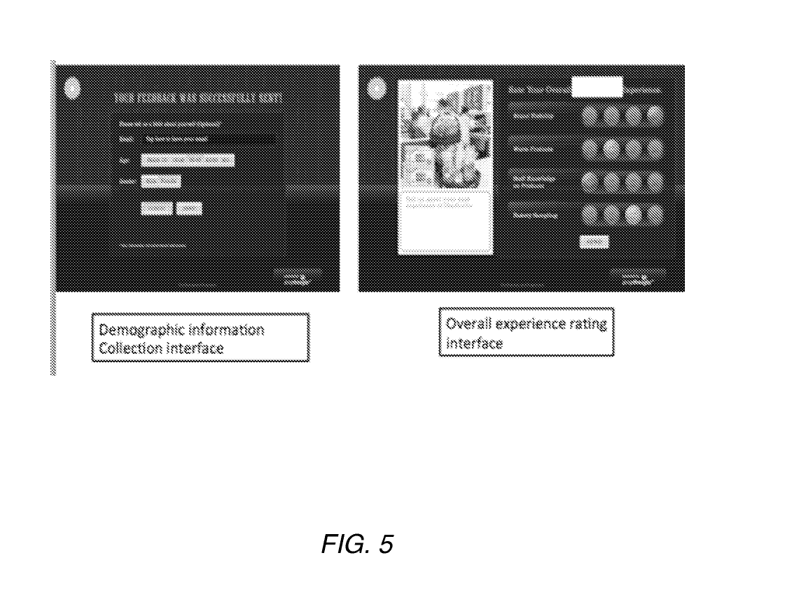

FIG. 5 shows a UI of a demographic information collection interface, and an experience rating interface, in accordance with one embodiment of the invention.

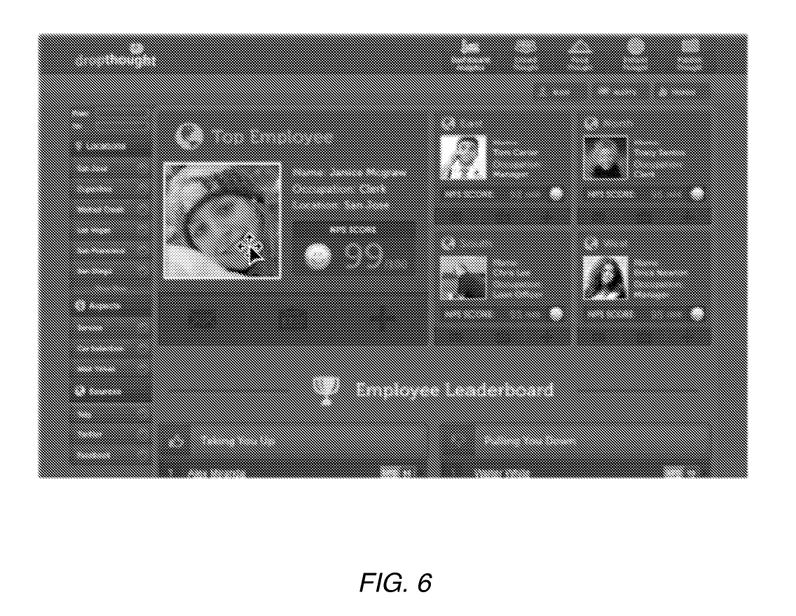

FIG. 6 shows an example of a manger dashboard for performance management, in accordance with one embodiment of invention.

### WRITTEN DESCRIPTION

Disclosed herein is a platform for experience management. Advantageously, the platform may be used to manage the experience of a customer according to different deployment scenarios, as will be explained.

FIG. 1 shows a high level deployment scenario 100, in accordance with one embodiment of the invention. Referring to FIG. 1, the deployment scenario 100 includes an Experience Management Platform (EMP) 102. In general, EMP 102 is defined by a computing platform and may include one or more computing devices (e.g., servers) configured to operate as a single computing platform, or a distributed computing platform.

In one embodiment, the EMP 102 may reside in the Cloud and may supports connections over networks to clients/customers via client side connections 104. For connections with business users, for example, managers, the EMP 102 may support connections over networks via business side connections 106.

In one embodiment, each of the connections 104, 106 may include wireless or wired communications systems. Thus, for example, the client side connection 104 may, in accordance with one embodiment, include a packet-based network such as the public Internet.

Typically, a client/customer 108 uses a client device 110 to connect to the EMP 102 via a client side connection 104. The client device 110 may include a smart phone provisioned with a Client User Experience (CUE) application 112. The CUE 112 may be used as tool for experience management, as will be described. In general, the client device 110 may include any computing device capable of connecting to EMP 102. As such, client device 110 may include a personal computer, a laptop computer, a tablet computer, etc. In some embodiments, the CUE application 112 may be implemented as a web widget, a kiosk provisioned with the CUE application 112 on a device (tablet,) a binder with a device (tablet) provisioned with the CUE application 112.

Typically, a manager 116 uses a manager device 118 which is similar to the client device 112, to connect to the EMP 102 via one of the business side connection 106. The manager device 118 may include an Manager User Experience (MUE) application 120 that facilitates experience management in cooperation with the EMP 102 by the manager 116, as will be explained.

In general, the client device 110 may be used to provide real time or live feedback to EMP 102. For example, a customer 108 may be at a restaurant and may use client device 110 to leave feedback relating to customer's experience at the restaurant as follows:
a) While at a restaurant, the customer 108 may launch the CUE 112 using the client device 110. In one embodiment, the restaurant may be provisioned in the CUE 112 as a business in respect of which feedback may be left. The customer 108 may leave feedback in the form of text, video, or audio feedback about his/her experience while dining at the restaurant.
b) The CUE 112 may be configured, in one embodiment, to transmit the feedback to EMP 102.

In one embodiment, the EMP 102 may be configured to receive live feedback from a plurality of clients/customers 108.

Responsive to the feedback, the EMP 102 may be configured to classify the feedback based on its content in order to facilitate the management of the feedback. For example, one embodiment, the EMP 102 may be configured to classify feedback into categories indicative of whether the feedback is of a positive or negative nature.

In one embodiment, feedback classified as described may be presented in the form of dashboard that is available for manager 116 to view by the MUE 120. Advantageously, in one embodiment, feedback that is of a particularly negative nature is elevated within the dashboard so that it is brought to the immediate attention of the manager 116. In response, manager 116 may respond to the feedback using the MUE 120 for some other method of communication such as for example initiating a telephone call to the client/customer 108.

In one embodiment, EMP 102 may be configured to track all manager replies to customer feedback and to poll customers after managers have provided their responses to feedback. The polling is in order to determine if a manager's response to feedback are satisfactory to customers.

For example, a customer 108 may leave feedback along lines of “the vegetarian pizza at your restaurant was awful”. Responsive to the feedback, the EMP 102 categories the feedback as of a particularly negative nature. This may be done by keyword analysis of the feedback. In this particular case, the keyword “awful” in a feedback message it is an indication that it is of a particularly negative nature. As a result, feedback is flagged/marked as being of a particularly negative nature in the dashboard shown to the manager 116 by the MUE 120.

In response, the manger 116 may respond with a message as follows: “I am sorry to hear that the vegetarian pizza was awful. We are taking steps to address this issue. Please do come back and sample our new pizza dishes. We would like to appreciate you as a customer by providing your next pizza free of charge”.

In one embodiment, the EMP 102 may be configured to poll the customer 108 to determine if the manager's response was found to be satisfactory. For example, the EMP 102 may be configured to send a polling message to the customer 108, via email or through the CUE 112. The polling message may ask a polling question similar to: “On a scale of 1 to 10, how would you rate the feedback from management?”. Based on the customer's response to the polling question, the EMP 102, in one embodiment, may be configured to calculate a Net Promoter Score (NPS) or a score similar thereto which may be provided to the manager 116 via the dashboard.

As noted above, the EMP 102 may be configured to serve different niche experience management channels. FIG. 2 of the drawings shows the different experience management channels, in accordance with one embodiment. As can be seen, the channels include an employee experience management channel, a patient experience management channel, product sampling and feedback experience management channel, a performance management process channel, and a third party vendor experience management channel.

### The Student User Management Channel

Based on the student experience management channel, the EMP 102 may be configured to implement a student experience management process as follows:

The student experience management channel may be used in both academic (classes, course content, assignments etc.) and non-academic (financial aid, counseling, facilities etc.) situations.

In both situations, a student provides feedback of their experience through the CUE application 112.

A unique identifier of the student is captured if they leave any sort of information such as email id or room number. (If student is logged on to the service, the information is automatically saved.)

If the feedback was negative and exceeds certain pre-defined level, a service provider (academic organizations, online education providers, facility managers etc.) receives real-time/immediate alert about the feedback via the MUE 120 as well as through web-based dashboards that may be accessed via phones, laptops, tablets etc.

Advantageously, the student experience management channel allows a service provider to catch complaints before a student can leave or post them on social media sites, and is able to resolve issues by replying to negative feedback with a regret note and/or a resolution of the complaint. The reply may be sent back to the student through email, mobile notification etc. using the unique identifier provided by the student.

If the feedback was positive, the service provider may be allowed to promote the feedback by publishing it to their own social media using web-based manager dashboard.

The student experience management channel allows student engagement and enrollments to increase. The NPS score of the provider is also increased through resolution of complaints and marketing of the positive ones.

By responding to the negative feedback on a real-time basis, a service provider converts disgruntled student to either promoter or neutral. In turn, the service provider avoids negative publicity and can enjoy positive marketing effects.

The service provider may enjoy increased student engagement and positive publicity through promoting positive feedback on their social media.

The service provider also manages it's resources more efficiently and improve its service/product quality by understanding student feedback.

### The Employee Experience Management Channel

Based on the employee experience management channel, in one embodiment the EMP 102 may be configured to manage an employee experience management process as follows:

The employee experience management channel may be used in both work related (performance, superiors, bonus etc.) and non-work related (cafeteria, fitness centers etc.) situations.

In both situations, an employee provides feedback of their experience through the CUE application 112.

A unique identifier of the employee is captured based on information such as email id or employee number. (If employee is logged on to an internal system, the information is automatically saved.)

If the feedback was negative and exceeds certain pre-defined level, an employer receives real-time/immediate alert about the feedback on via the MUE 120 or through a web-based dashboard that can be accessed via a phone, laptop, tablet etc.

An employer catches complaints before the employee share them with others or post them on the social media sites. The employer may resolve issues by replying to negative feedback with a regret note and/or a resolution of a complaint. The replies are sent to the employee through an email, mobile notification etc. using the unique identifier provided.

If the feedback was positive, an employer may publish the feedback to their own social media site or internal system using a manager dashboard.

Employee engagement, motivation and retention rate may increase through resolution of complaints and marketing of the positive ones.

By responding to the negative feedback on a real-time basis, an employer converts an unsatisfied employee to either a promoter or a neutral employee. Advantageously, an employer avoids negative publicity on public review sites such as Glassdoor, and prevents internal morale issues.

Employers enjoy increased employee engagement and positive word-of-mouth effects through promoting positive feedback on their social media sites or internal systems.

An employer also manages its resource more efficiently and improve quality of service provided to an employee by understanding employee feedback.

The collected feedback may also be used in performance appraisals.

### The Patient Experience Management Channel

Based the patient experience management channel, the EMP 102 may be configured to manage a patient experience management process, in accordance with one embodiment of the invention, as follows:

The patient experience management channel may be used in both non-medical and medical related patient (hospital cleanliness, noise levels, waiting area etc.) and non-medical and medical related family (hospital cleanliness, noise levels, waiting area etc.) experience situations.

In both situations, a service consumer provides feedback of their experience through the CUE 112.

A unique identifier of the consumer is captured based on information such as an email id, room number, or patient number. (If patient is logged on to an internal system, the information is automatically saved.)

If the feedback is of a negative and exceeds a certain pre-defined level, a service provider receives a real-time/immediate alert about the feedback on the MUE 120 as well as through a web-based dashboards that can be accessed via a phone, laptop, tablets etc.

A service provider catches complaints before a patient leaves or post the complaints on social media sites, and resolves issues by replying to negative feedback with a regret note and/or a resolution of the complaint. The replies are sent to the patient through an email, mobile notification etc. using the unique identifier provided.

If the feedback was positive, the service provider may publish the feedback to their own social media site using a web-based manager dashboard.

Patient satisfaction and retention rate increases, as well as NPS scores of the provider through resolution of complaints and the marketing of the positive ones. A provider also generates incremental revenues through higher patient satisfaction scores which is mandated by the Affordable Care Act.

By responding to the negative feedback on a real-time basis, a service provider converts unsatisfied consumer to either a promoter or a neutral consumer. In turn, a provider avoids negative publicity, potential mal-practice lawsuits and can enjoy positive word-of-mouth effects.

A service provider enjoys increased patient satisfaction and positive word-of-mouth effects through promoting positive feedback on their social media sites.

A Service provider also manages its resource more efficiently and improve service quality by understanding consumer feedback.

### The Product Sampling and Feedback Experience Management Channel

Based on the product sampling and feedback process channel, the EMP 102 may be configured to manage a product sampling and feedback process, in accordance with one embodiment, as follows:

The product sampling and feedback experience management channel may be used to gather feedback on new and existing products at a point of sale. This mechanism enables actual product testing and sampling in a true consumption environment and is invaluable for product innovation, development and testing.

A customer gets more information about the product such as ingredients, calories, allergens, etc. In one embodiment, this information is provided via a kiosk provisioned with a CUE 112.

A consumer provides feedback of the sample product through the CUE 112.

A unique identifier of the consumer may be captured based on information such as an email id or demographics. (If a consumer is logged on to an internal system, the information is automatically saved. Incentives such as gift-cards may be provided to encourage customers to provide their contact/demographic information.)

Management may access detailed trends on product performance with consumers through intuitive dashboards.

If the feedback is negative and exceeds certain pre-defined level, a product provider receives real-time/immediate alert about the feedback via the MUE 120 as well as through a web-based dashboard that can be accessed via a phone, a laptop, a tablet etc. A product provider may resolve issues by replying to negative feedback with a regret note and/or a resolution of the complaint. This reply may be sent back to the customer through an email, mobile notification etc. using the unique identifier provided.

If the feedback is positive, a product provider may publish the feedback on their own social media site using a web-based manager dashboard.

The product sampling and feedback experience management channel allows for actual product testing and sampling in a true consumption environment. This is invaluable for product innovation, development and testing. The product sampling and feedback experience management channel complements and addresses the gaps present in the current testing methodologies such as:

In-store sampling: ad-hoc and mostly verbal feedback, over the counter feedback given to a representative induces a bias on the consumer side, Prone to manual translation errors from representatives as well maintaining and tracking feedback is a challenge

Expert Testing: Generates false negatives—Experts tend to reject a lot of products, some of which may have the potential of success with actual consumers; Small sample sizes may not be reflective of customer preferences

Mall Intercepts: Artificial and busy environment—unfit for testing; Often proves to be a stressful experience for the consumer and lowers the credibility of responses

Blind Taste Testing: Often performed in labs and not in a real consumption environment; Impact of brand name on consumption experience cannot be assessed

A product provider improves its product quality and make changes to recipe/ingredients/suppliers by capturing detailed trends on taste, recipe and ingredient preferences. This feedback may be shared with suppliers, in one embodiment.

The product sampling and feedback experience management channel may be used to improve customer satisfaction and retention rates, as well as to NPS scores of the provider through the resolution of complaints and marketing of the positive ones.

### The Performance Management Process Channel

Based on the performance management channel, EMP 102 may be configured, in accordance with one embodiment, to manage a performance management process, in accordance with one embodiment, as follows:

The performance management process channel may be used to link a consumer's experience to an employee in-charge of driving consumer experience. For example, in a restaurant, the performance of a waiter at a table may be tied to the experience of consumers at that table.

A consumer provides feedback of the employee service through the CUE 112.

Management accesses detailed information of their employee's performance with consumers through intuitive dashboards.

If the feedback is negative and exceeds a certain pre-defined level, management receives a real-time/immediate alert about the feedback via the MUE 120 as well as through web-based dashboards that can be accessed via a phone, laptop, tablet etc. A manager can resolve issues by replying to negative feedback with a regret note and/or a resolution of the complaint. This sent back to the customer through email, mobile notification etc. using the unique identifier provided.

If the feedback was positive, the manager/provider may promote/publish the feedback on their own social media site using a web-based manager dashboard.

Advantageously, management may the feedback as an input into a performance management process for appraisals and to determine bonuses and other incentives of employees.

Employee engagement, motivation and retention rates increase through use of the performance management process channel.

A manager may also manage employee resource more efficiently and improve service quality by increased employee motivation.

### The Third Party Vendor Experience Management Channel

Based on the third party vendor experience management channel, the EMP 102 may be configured, in accordance with one embodiment, to manage a third party vendor experience process as follows:

The third party vendor experience management channel may be used by businesses to evaluate the performance of third-party vendors that they deploy in consumer interactions, such as a manufacturing company that outsources repairs of equipment to a third party.

When consumers interact with the third party, they provide instant feedback on their experience with the vendor through the CUE 112

A unique identifier of the consumer may be captured through information such as an email id or demographics. (If consumer is logged on to an internal system, the information is automatically saved.)

A business may access detailed information of their third-party vendor performance with consumers through intuitive dashboards.

If the feedback was negative and exceeds certain pre-defined levels, management receives real-time/immediate alert about the feedback via the MUE 120 as well as via a web-based dashboard that can be accessed via a phone, a laptops, a tablet etc. A manager may resolve issues by replying to negative feedback with a regret note and/or a resolution of the complaint. This reply may be sent to the customer via an email, mobile notification etc. using the unique identifier provided.

If the feedback was positive, the manager/provider may promote or publish the feedback on their own social media site using a web-based manager dashboard.

A business may evaluate third party vendor performance based on the feedback. The business may use these insights in renewing/terminating contracts.

Third vendor's performance, motivation and engagement increase through use of the third party vendor experience management channel. The result is that the business manages its resource more efficiently and improves service quality.

Customer satisfaction and retention rate increase, as well as the NPS score of the business through resolution of complaints and marketing of the positive ones.

Referring to FIG. 3 of the drawings there is shown a sample user interface (UI) for product sampling and feedback management, in accordance with one embodiment. Referring to UI of FIG. 3, a main interface shows a catalog of products, whereas customers product rating interface allows a customer to rate a product.

FIG. 4 of the drawings, shows another example of a user interface (UI) product information interface, and a product review interface, in accordance with one embodiment.

FIG. 5 of the drawings, shows a UI of a demographic information collection interface, and an experience rating interface, in accordance with one embodiment of the invention.

FIG. 6 shows an example of a manger dashboard for performance management, in accordance with one embodiment of invention. Referring to FIG. 6, employees NPS scores are shown in order to track how effective particular employees are in addressing concerns that might have been raised by customers.

1. A computer-implemented method, comprising:
receiving feedback messaged from a plurality of users via a network, each feedback message capturing user experience information for a user;
classifying the feedback messages based on content into at least two categories comprising a negative category for feedback messages of a negative nature and a positive category comprising feedback messages of a positive nature;
providing a dashboard for a manger to view at least the feedback message in the negative category, and marking those feedback messages that are most negative in nature; and
polling each user who sent a feedback message of a negative nature to determine if a reply to said feedback message for found to be satisfactory.
